(19) United States
(12) Patent Application Publication
(10) Pub. No.: US 2007/0249370 A1
(43) Pub. Date: Oct. 25, 2007

(54) Method of Effecting Access to Services in a Telecommunication Network

(76) Inventor: Henryk Kulakowski, Stalowa Wola (PL)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/583,129

(22) PCT Filed: Feb. 29, 2004
(86) PCT No.: PCT/PL04/00015

§ 371 Date: Mar. 26, 2007

(30) Foreign Application Priority Data
Dec. 17, 2003 (PL) P.364119

(51) Int. Cl. H04Q 7/20

(52) U.S. Cl. 455/466

(57) ABSTRACT

A method of effecting access to services in a telecommunication network is the fact that the service can be accessed from the user's terminal identically and simultaneously with the use of two complementary interfaces: a voice and a text terminal with the use of USSD commands, where the service is effected when the user initiates a connection with the service access number, which in the case of a voice interface is treated as a telecommunication number of the chosen service, and in the case of a text interface it is treated as a USSD command, consisting of the same digit sequences, and differing only in the characters ,,*” and ,,#”, included therein, whereas the differences are responsible for choosing a channel by the telecommunication network, and what comes with it, also for choosing of an interface, through which the user's connection with the service would be effected, and the decision on how this connection is to be handled preferably is made by the service, basing on information related to the incoming connection, received either directly from the telecommunication network or indirectly from the telecommunication operator.

### FIELD OF THE INVENTION

This invention relates to a method of effecting access to services in a telecommunication network.

### BACKGROUND OF THE INVENTION

A number of solutions are known which make it possible to effect interactive services in telecommunication networks. The most popular ones are voice services based on IVR systems. The user calls the specified telephone number of the given voice service, where he uses the service with his telephone keyboard, operating under DTMF tone dialing. Examples of such systems can be found in WO0145086 or US2001028705.

Strings of DTMF characters, dialed during the session of the telephone connection, can be also sent automatically, without waiting for subsequent messages from the IVR system. A string of such characters is given directly after the telephone number of the service, finished with a pause character, after which then a sequence of DTMF characters is given. In practice, such a solution causes the telephone set to dial the service number first, then to wait for the answer signal, and after that to send the given DTMF sequence.

Very popular are all kinds of services for mobile phones with the use of SMS text messages. Here, the user sends any text of specified length under the specified service number. An example for that can be the parking system described in WO9719568. In case of a greater interaction of the user with the service, a greater number of SMS messages are exchanged. An example for that can be the electronic auction system described in WO0022906.

Services based on WAP make it possible to provide the user not only with texts, but also with graphic elements or sounds. They also make it possible to fully interact with the user, however, the communication interface on the user's side is always a text interface. An example for that can be the system for ordering goods and services, described in WO03003143.

A less popular method of effecting interactive services is application of a USSD channel, which allows for simple effecting of interaction with the user, but also offers only a text interface.

A characteristic feature of the above mentioned solutions is the fact that the service is provided within one technology or one communication channel, and effecting of the service in a different channel requires the user to use the service in a different way.

The USSD (Unstructured Supplementary Service Data) is a method of exchanging information between a mobile telephone and a telecommunication operator, described in standards ETSI GSM 2.30, GSM 4.90, GSM 2.90, and used mainly for configuration of services and parameters in a GSM network.

The aim of this invention is a method of effecting access to services in telecommunication networks, making it possible for the user to gain simple access to such services directly from the telephone keyboard, and at the same time making it possible to choose the interface type and to have the option of choosing the way in which the connection is to be handled by the service operator.

### SUMMARY OF THE INVENTION

This aim has been accomplished in the method of effecting access to services in a telecommunication network, according to the invention which has this characteristic feature that the service can be accessed from the user's terminal identically and simultaneously with the use of two complementary interfaces: a voice and a text terminal with the use of USSD commands, where the service is effected when the user initiates a connection with the service access number, which in the case of a voice interface is treated as a telecommunication number of the chosen service, and in the case of a text interface it is treated as a USSD command, consisting of the same digit sequences, and differing only in the characters ,,*” and ,,#”, included therein, whereas the differences are responsible for choosing a channel by the telecommunication network, and what comes with it, also for choosing of an interface, through which the user's connection with the service would be effected; and the decision on how this connection is to be handled preferentially is made by the service, basing on information related to the incoming connection, received either directly from the telecommunication network or indirectly from the telecommunication operator.

Preferably, the access number contains additional parameters separated with a character “*” or “#”; these parameters are given by the user either preferably during the initiation of a telecommunication connection, or alternatively already during the connection session, whereas the parameters given during the connection session are preferably alphanumerical data.

Preferably, the text interface can be any other interface, including an interface for SMS text messages, where numbering identical as in a voice interface is used for the access to the service.

Preferably, the term of access to the service includes also access or connection to another user. The term of a connection includes also a set or a sequence of voice or text messages exchanged between the user and the service without the need to establish a physical connection.

The method according to the invention is also characterized in that the access to the service and the subsequent connection take place in two different interfaces, available within the service.

A tremendous advantage of this invention lies in the fact that the choice of the interface for communication with the user is effected already when setting up a connection with a simple combination of the characters “*” or “#” in the service access number, dialed on the phone, whereas parts of the data integrated with the access number can be transmitted to the service already at the stage of the connection being initiated. The remaining part of information is exchanged between the user and the service during the connection session, whereas the basic difference lies not in the content of the information being transmitted, but in the method of their transmission to the user: through voice or text. The invention has an additional advantage as well: it makes it possible for the service operator to preliminary handle the incoming connection, basing on the service number and the therewith integrated information, received either from the telecommunication network, or from the telecommunication operator. Depending on the outcome of this operation, the service operator shall make a decision on the appropriate handling of the connection, e.g. it can be accepted or denied. If the service cannot offer an appropriate service to the user—the connection is not accepted, so that the user does not bear any costs.

### DETAILED DESCRIPTION OF THE PREFERRED EMBODIMENTS

A user who wants to use the service, dials on the telephone keyboard the access number of the service operator, which, apart from digits, consists among others of the characters “*” and “4”. The service is available via two different interfaces: voice and text mode, effected with the use of USSD. In both cases, the access number is identical and differs only in the occurrence of the characters “*” and “#” in the sequence dialed on the user's terminal. In case of a USSD sequence, it is precisely defined by specific standards. In case of a voice connection, it has to contain a different valid combination of the mentioned characters. Depending on the occurrence of sequences of characters “*” and “#” in the access number chosen by the user, the initiated connection is identified by the telecommunication network as a USSD connection or a voice connection, which reaches the service operator through an appropriate channel. In both cases, a connection with the user is established, during which interactive data exchange takes place. In case of a USSD connection, the user's terminal displays a text, and the user has the option of sending the text to the service operator as well. In case of a voice connection, it is handled e.g. by an IVR system, where the user receives voice messages instead of texts, and the user's own information can be sent with the telephone keyboard in the DTMF tone system or dictated to a speech recognition system.

Information transmitted to the service operator by the user is provided both during the connection session and preferably during its initiation, by dialing on the telephone keyboard—together with the access number—of a sequence of digits, preferably separated by valid characters “*” or “#”.

After the telecommunication connection has been initiated by the user, it is directed to the service operator, where, on the basis of data coming directly from the telecommunication network of indirectly from the telecommunication operator, the service operator shall decide whether and with which method this connection is to be handled. Each connection can be for example handled individually, depending on the identification of the number of the person initiating the connection.

### EXAMPLE 1

The service provides downloading of melodies for a GSM phone. The service is available under the access number “*145” for a voice interface. When dialing this number, the user connects to an IVR system, which asks the user by the voice method to enter the six-digit melody_code and the two-digit telephone_code, characterising the melody type handled by this telephone. After all the data have been entered, the connection is disconnected, and the user receives the ordered melody to his telephone. The user can begin from dialing the sequence “*145*melody_code*telephone_code” on the telephone keyboard, where, after the setting up of the connection, the IVR system processes the received data and sends the ordered melody to the user—even without the need to set up a voice connection.

In case of a text interface, connection to the service office is initiated in an identical way, whereas the dialed number is finished with the character “#”: ,,*145#”. Such a connection is directed by the telecommunication reception to the USSD server, where it is passed on to the service operator. The service can be used also here by sending the necessary parameters together with the access number. In such a case, the sequence “,,*145*melody_code*telephone_code#” should be dialed from the telephone keyboard.

### EXAMPLE 2

Listening to a radio station, the user has the possibility to order via phone the presently broadcasted song as a melody for the phone. This service is available under the number “*145”; having connected with this number, the user has to enter a two-digit telephone code, characterising the phone manufacturer, which in his case is “01”. In case of a connection with the service via a text interface (USSD), the user dials the sequence “*145*01#”, and in case of a voice connection—the sequence “*145*01*”. The connection is directed by the telecommunication network to the service operator, who analyses the access number, for which the connection had been initiated, and whether this number includes the telephone code. If the song broadcasted by the radio station is not available or is available in formats that are not compatible with the user's telephone, then the connection is not accepted or the user receives an appropriate message on the unavailability of this song. As the sequence dialed by the user when initiating a connection is always fixed, he can write it down, e.g. in his phone book.

### EXAMPLE 3

Listening to a radio station, the user connects to the service under the number “*145*” for a voice service or “*145#” for a text service. Having established a connection with the service, the user can: 1. order the broadcasted song in the form of an MP3 file, 2. order the album of the broadcasted singer, 3. order a melody for the phone or 4. vote for a song in music charts. The user selects the appropriate option. In case of a text channel, the user enters a digit from 1 do 4 from his keyboard. In case of a voice connection, the user speaks out the appropriate digit, which is accordingly interpreted by the speech recognition system.

### APPLICATIONS IN INDUSTRY

Implementation of the proposed invention allows for effecting of a new type of added services in telecommunication networks. The proposed invention makes using of the invention much simpler for the users than in the case of e.g. services based on SMS. The possibility to effect services on two complementary interfaces—in voice and text mode—gives much greater possibilities to provide services and has more advantages as seen by the users. The possibility to communicate with two channels is of great importance, especially in the case of mobile phones, where the user is not always able to use the text interface (e.g. when driving a car), or the voice interface (during a meeting). The invention makes it also possible to find new application areas for IVR and USSD systems. It also gives the possibility to effect interactive services, which are limited by interfaces and solutions used so far.

1. A method of effecting a telecommunication connection to a service in a telecommunication network comprising:
establishing a telecommunication connection from a user's phone terminal to an access number of a telecommunication service server in either a voice interface or a text interface,
wherein the access number comprises a beginning character of either “*” or “#”, followed by a sequence of digits, and an optional ending character of “#”,
wherein the presence of the optional ending character determines that the connection will be effected by means of the text interface using USSD commands and the lack of the optional ending character determines that the connection will be effected in the voice interface, and
wherein the access number is always the same number for the voice interface and the text interface.

2. A method according to claim 1 wherein the access number further comprises additional parameters, separated with the characters of asterisk “*” or hash mark “#”, wherein the additional parameters are inputted by the user during the connection.

3. A method according to claim 1 where the text interface is realized within any other than the USSD commands.

4. A method according to claim 1 wherein the telecommunication connection to a service in a telecommunication network comprises a connection to another user.

5. A method according to claim 1 wherein the telecommunication connection comprises a set of a sequence of voice or text messages exchanged between the user and the services without the need to establish a session or a physical connection.

6. (canceled)

7. A method according to claim 1 wherein the text interface is realized within any text interface other than the USSD commands.

8. A method according to claim 7 wherein the text interface is realized within a short text message interface of an SMS service.

9. A method according to claim 1 wherein the text interface is realized within any text channel other than the USSD commands.

10. A method according to claim 9 wherein the text interface is realized within a short text message channel of an SMS service.
